(19) United States
(12) Patent Application Publication
(10) Pub. No.: US 2011/0234602 A1
(43) Pub. Date: Sep. 29, 2011

(54) Numeral inputting method

(76) Inventor: Kwok Chung Wong, El Monte, CA (US)

(21) Appl. No.: 12/798,098

(22) Filed: Mar. 29, 2010

(51) Int. Cl. G09G 5/26

(52) U.S. Cl. 345/472.3

(57) ABSTRACT

A numeral inputting method that defines a set of sequence codes representing the Chinese character such that the numeral inputting method is capable of inputting several different languages such as English and Chinese through inputting ten Arabic numbers such that using the numeral inputting method for different language inputting has became easy to learn and use.

### BACKGROUND OF THE PRESENT INVENTION

1. Field of Invention

The present invention relates to an inputting method, and more particularly to a numeral inputting method which is capable of inputting several different languages such as English and Chinese through typing ten Arabic numbers keyboard such that using the numeral inputting method for different language inputting has became easy to learn and use.

2. Description of Related Arts

Characters are the smallest units used to represent languages for writing. In the world, majority languages are using phonetic writing which employs a limited number of letters to assemble different characters with different arrangement corresponding to the phonemes. Therefore, besides hand-writing, to input the characters to paper or electronic devices such as computer, using a plurality of keys each mapping a letter is the most obvious and effective method. For example, a typewriter as the traditional way, or modern keyboard. The user only need to remember the position of limited letters (26 as English for example) distributed on the typewriter or keyboard, then he/she can input any characters by selecting the corresponding letters according to the spelling of the characters.

But there are some languages which are using logograph system to represent a word or a morpheme, the smallest meaning unit. The most popular logography script system is Chinese characters. In these languages, each word is represented by one unique logograph, characters are distinguished from each other by their symbolic appearance or structure of the character, therefore thousands of words have thousands of logograph. Before computer is invented, there was no successful method to input Chinese characters by using limited symbols to assemble different characters. As a result, the traditional Chinese typewriter must have a huge key board containing every needed character keys with the logograph preformed on the keys. Only professional operators can use this type of typewriter because he/she needs to remember the distribution of the keys and accurately pick the correct one. Considering there are four to five thousand frequently used characters, it is very inconvenient.

After the invention of computer, many electrical inputting methods are developed. There are two major concepts of Chinese character inputting method: one is based on the pronunciation of the character, one is based on the structure of the character. For methods based on the pronunciation, each Chinese character is spelled using the English letters a to z according to the pronunciation of the character, for example, the “Pinyin” method and the “Zhuyin” method. The obvious advantage of this type of inputting method is it is use to learn, especially for people can pronounce the character correctly and know how the principle to spell. But the disadvantage is also obvious. If the user can not pronounce the character correctly, the right word won't come. Chinese has many dialects, people live in different area may have different pronunciation for a same character. This gives a lot of trouble for people with accent. Also, Chinese has a lot of homophones. Almost every character shares the same pronunciation with others. Because for homophones the spelling are the same, the user has to select the character manually. This largely decreases the inputting speed, and the user can not input without monitoring the screen.

It is obvious to think about using the structure components as the basic unit for inputting. Chinese character is constructed by one more strokes. These strokes are relatively positioned in a square area which represents the size of the character. During writing, the strokes also follow a sequence. Since in every Chinese character the position and shape of strokes are different, there are too many strokes to define. Chinese characters also have a structural component called radical. Radicals are constructed by one of several strokes. Some radicals may represent the meaning of the character, some radicals may represent the pronunciation of the character. Radicals largely limit the variety of Chinese character strokes, but the number is still much larger than letters of phonemic languages.

For currently used inputting methods based on the structures, they are also using the standard keyboard. Each English letter is encoded to represent one or a group of special structures. To assemble all or portion of the structure of a character by typing the corresponding letters, a character is input. This type of input methods can be much faster used by an experienced user. Each input may be unique, and the user can input without watching the screen. But the biggest problem of this type of inputting method is the user has to remember the complex encoding principle, and has to be well trained for a while.

In addition, almost all modern inputting methods are using a standard keyboard or alike. Such kind of keyboard is large and not convenient to carry, not suitable for portable devices. Using this type of keyboard also involves both hands of the user.

There are some inputting methods employed by portable electronics devices such as cell phone, PDA, etc. These methods generally use a minimized keyboard or a touch screen simulated keyboard, and are even more difficult to use.

Moreover, these currently used inputting methods cannot input different languages at the same time. For example, to input text mixed with both Chinese and English, the input methods have to be switched back and forth between Chinese inputting method and English inputting methods. For Chinese characters, an option has to be selected to input traditional Chinese characters or simplified Chinese characters.

Therefore, it is necessary to develop a new inputting method.

### SUMMARY OF THE PRESENT INVENTION

An object of the present invention is to develop an inputting method for characters of different languages.

Another object of the present invention is to develop an inputting method which employs a portable keyboard with limited number of keys.

Another object of the present invention is to develop an inputting method which is easy to learn.

Another object of the present invention is to develop an inputting method which is convenient to use.

Another object of the present invention is to develop an inputting method supporting logographic characters.

Another object of the present invention is to develop an inputting method supporting Chinese characters.

Another object of the present invention is to develop an inputting method which is able to be used in portable electronic devices.

Another object of the present invention is to develop an inputting method which is based on the appearance of the characters.

Another object of the present invention is to develop an inputting method which inputs different languages and standards of characters at the same time.

Another object of the present invention is to develop an inputting method using Arabic numerals as the key of inputting.

Accordingly, in order to accomplish the above objects, the present invention provides a numeral inputting method for different languages, comprising the steps of:

(a) assigning an Arabic number “0” to “9” to each basic unit of characters of different languages, wherein the character is divided into one or more basic units with a sequence;

(b) inputting two or more said numbers to represent different languages to be selected, wherein the number is input according to the appearance of the basic unit; and

(c) generating the character in the language in responsive to the numbers being input.

In addition, the present invention also provides a numeral inputting system for different languages, comprising:

a plurality of input keys having a plurality of Arabic number “0” to “9” assigning to each basic unit of characters of different languages, wherein the character is divided into one or more basic units with a sequence, wherein two or more the numbers are input to represent different languages to be selected, wherein the number is input according to the appearance of the basic unit; and

means for generating the character in the language in responsive to the numbers being input.

These and other objectives, features, and advantages of the present invention will become apparent from the following detailed description, the accompanying drawings, and the appended claims.

### DETAILED DESCRIPTION OF THE PREFERRED EMBODIMENT

The concept of the present invention of numeral inputting method is using the Arabic numerals “0” to “9” to describe the structure of a character. Since each Arabic numeral has a unique structure or shape, this unique structure can be used to simulate one stroke or one structure which is constructed by several strokes of a character. When every stroke or structure of the character is simulated by corresponding Arabic numerals consequently, the whole structure of the character is described by the corresponding Arabic numerals. Therefore, by inputting these Arabic numerals, the character is defined and will be recognized by the inputting method and device.

In a preferred embodiment of the present invention, the inputting method is used to input English, and Chinese, as the examples. The first step is to define the basic units of each language by a number value. The principle of the definition is using the appearance of the Arabic numbers to simulate the appearance of the basic unit of each language.

According to the preferred embodiment, the numeral inputting method for different languages comprises the following steps.

(1) Assign an Arabic number “0” to “9” to each basic unit of characters of different languages, wherein the character is divided into one or more basic units with a sequence.

(2) Input two or more said numbers to represent different languages to be selected, wherein the number is input according to the appearance of the basic unit.

(3) Generate the character in the language in responsive to the numbers being input.

The basic units of English are the 26 letters from “A” to “Z”. The basic units of Chinese are the strokes or group of strokes. Some strokes together form a radical, which is also a basic unit of Chinese characters. Accordingly, the basic unit is assigned by one digit of the number.

In the preferred embodiment, for Arabic number inputting, each number character of 0-9 is represented by one Arabic number which is the number itself. 0 represents “0”, 1 represents “1”, . . . , and 9 represents “9”. Therefore, in the numeral inputting method of the present invention, inputting one number means inputting an Arabic number.

According to the preferred embodiment, the present invention also provides a numeral inputting system for inputting different languages, wherein the system comprises a plurality of language databases for storing the characters in the different languages respectively, and a plurality of input keys having a plurality of Arabic number “0” to “9” assigning to each basic unit of characters of different languages. Accordingly, the input keys can be embodied as a keyboard having a plurality of Arabic number keys from “0” to “9” in order for the user to key in the numbers.

The system further comprises means for generating the character in the language in responsive to the numbers being input. Accordingly, the generating means comprises a processor linked with the language databases to generate the character of the corresponding language in responsive to the input numbers.

In the preferred embodiment, for English inputting, each letter is represented by two Arabic numbers. The 26 letters are separated into groups, with each group comprising a series of letters that appear similar to the Arabic numerals 0-9. For those few characters that do not look like a number, there value is assigned based on the letter's connection to a number, such as the letter V being assigned the value 5 because it looks like the Roman numeral for five.

The first group contains letters of “DHRMFKGLBP”. Except G, the letters DHRMFKLBP all have a first vertical left stroke. This vertical stroke looks similar to a “1” and thus all these letters will be assigned a number from 10-19. The table below indicates the letter, its numerical equivalent, and reasoning for the assignment.

TABLE 1

| Letter | Reason for Assignment of Numerical | Value |
|---|---|---|
| D | It looks similar to 0 | 10 |
| H | It has two vertical strokes which looks like two 1 | 11 |
| R | The right hand side of the R looks similar to the rounded | 12 |
| | side and bottom of a 2 | |
| M | Rotate M 90° clockwise and it looks like 3 | 13 |
| F | Rotate the letter 90° counter-clockwise and it looks | 14 |
| | similar to a 4. Moreover, four is spelled with an F | |
| K | Rotating the last two strokes 90° counter-clockwise | 15 |
| | looks like the Roman numeral for the number 5 | |
| G | It has a similar shape to 6 | 16 |
| L | By rotating the letter counter-clockwise 180° it looks | 17 |
| | like 7 | |
| B | The right edge of the letter looks like the right edge of | 18 |
| | the number 8 | |
| P | It looks like a 9 reflected across a vertical axis | 19 |

The second group contains letters of “OIUEAYCTSN”. This group, with the exception of Y and N also look similar to the Arabic numbers 0-9. Since this is the second group of letters, this group will begin with 2.

TABLE 2

| Letter | Reason for Assignment of Numerical | Value |
|---|---|---|
| O | It looks similar to 0 | 20 |
| I | It looks similar to 1 | 21 |
| U | Rotate U 90° counter-clockwise and its rounded looks | 22 |
| | similar to 2 | |
| E | The letter E reflected across a vertical axis looks similar | 23 |
| | to 3 | |
| A | Rotate clockwise 45° degree and remove the bottom | 24 |
| | portion of the left leg and it looks like 4 | |
| Y | Its upper two strokes make a V shape like the Roman | 25 |
| | character 5 | |
| C | The letter has a similar curving shape like 6 | 26 |
| T | Remove the right hand side of the top bar and it looks like | 27 |
| | a 7 | |
| S | It looks similar to 8 | 28 |
| N | It is the first letter of nine | 29 |

The third group contains the remaining 6 letters of “QJZWXV” are also assigned a numerical value. The third series of letters resemble the numbers 0-5 and are assigned numerical values of 30-35, respectively.

TABLE 3

| Letter | Reason for Assignment of Numerical | Value |
|---|---|---|
| Q | It looks similar to 0 | 30 |
| J | It looks similar to 1 | 31 |
| Z | It looks similar to 2 | 32 |
| W | Rotate counter-clockwise 90° degree it looks similar to 3 | 33 |
| X | X and 4 both have crossing strokes | 34 |
| V | It looks like the Roman number 5 | 35 |

As described above, each English letter is represented by two numbers. If only two numbers are inputted continuously, it means an English letter is inputted.

In an alternative embodiment of the present invention, the 26 letters are separated into groups as following:

Regulation 1, letters which have a first vertical left stroke are assigned from 10-19, such as “DHRMFNKLBP”.

Regulation 2, letters which have no first vertical left stroke, and are not vowels are assigned from 20-29, such as “QJZWXVCTSG”.

Regulation 3, vowels and semi vowel are assigned from 30-35, such as “OIUEAY”.

In the preferred embodiment, for Chinese inputting, each Chinese character is represented by three or more Arabic numbers. The smallest structure unit of Chinese characters is stroke. One or more strokes form a plurality of radicals. Assembling these radicals in particular position forms various Chinese characters.

The Chinese inputting system arranges the following Chinese strokes to number character 0-9 based on a stroke's similarity to a number as bellow:

TABLE 4

| Value | Strokes | Explanation | C.N. | Strokes | Explanation |
|---|---|---|---|---|---|
| 1 | \| [symbol] | Similar to 1. | [symbol] | [symbol] | Similar to [symbol] . |
| 2 | [symbol] | Similar to 2. | [symbol] | [symbol] | 2 strokes, drops |
| | | | | [symbol] | or slash. |
| 3 | [symbol] | Similar to 3. | [symbol] | [symbol] | 3 drops. |
| | [symbol] | | | | |
| 4 | [symbol] | Similar to 4. | [symbol] | [symbol] | 4 drops. |
| | [symbol] | A pierce through | | [symbol] | Similar to [symbol] |
| | \| | vertical stroke | | [symbol] | |
| | | is 4. not 1. | | | |
| 5 | [symbol] | Similar to the top | [symbol] | [symbol] | Similar to Roman |
| | | or botom of 5. | | [symbol] | number V, 5 |
| 6 | [symbol] | Similar to 6. | [symbol] | [symbol] | Similar to [symbol] |
| 7 | [symbol] | Similar to 7. | [symbol] | [symbol] | Similar to [symbol] . |
| 8 | [symbol] | Similar to 8. | [symbol] | [symbol] | Similar to [symbol] . |
| 9 | [symbol] | Similar to 9. | [symbol] | [symbol] | Similar to [symbol] . |
| 0 | [symbol] | Similar to 0. | [symbol] | | |

The strokes | and [symbol] look like Arabic number 1. The stroke [symbol] is similar to Chinese number [symbol] . Therefore, Arabic number 1 represents strokes | [symbol] and [symbol] .

The meaning of the strokes [symbol] and [symbol] is 20. The strokes [symbol] and [symbol] have two individual 1, [symbol] have two slash, therefore Arabic number 2 represents strokes

[symbol]

[symbol]

The strokes [symbol] look like Arabic number [symbol] is also composed of 3 points. Therefore Arabic number 3 represents strokes

[symbol]

The [symbol] looks similar to 4. [symbol] looks similar to an upside down 4, [symbol] [symbol] look like Chinese number four [symbol] four points, [symbol] has four horizontal line therefore Arabic number 4 represents strokes

[symbol]

[symbol]

The stroke | also represent 4, if it piercing through other stroke.

The [symbol] and [symbol] look like Arabic number 5, [symbol] look like the Rome number V, therefore, Arabic number 5 represents strokes

[symbol]

[symbol] looks like 6, [symbol] looks like Chinese character [symbol] the first two strokes of Chinese character [symbol] therefore, Arabic number 6 represents strokes

[symbol]

[symbol] looks like 7, [symbol] looks similar to 7 [symbol] look similar to Chinese character [symbol] therefore Arabic number 7 represents strokes

[symbol]

[symbol] looks like 8, Chinese character [symbol] consists of [symbol] and [symbol] look like Chinese character [symbol] therefore, Arabic 8 represents strokes

[symbol]

[symbol] looks similar to Arabic number 9, [symbol] and [symbol] look similar to [symbol] which pronunciation is the same as 9 in Chinese, looks similar to Chinese number [symbol] therefore, Arabic number 9 represents strokes

[symbol]

[symbol] looks similar to Arabic number 0, therefore Arabic 0 represents stroke

[symbol]

The second step is to divide characters into basic units with sequence.

For English inputting, each English word is formed by one or more letters which are the basic units, the sequence is from left to right. For example, “word” is divided into “w”, “o”, “r”, and “d” in sequence.

For Chinese inputting, each character is divided into strokes or radicals. The sequence is generally from left to right, from top to bottom, from outside to inside.

The third step is to input the numbers which represent the basic units following the sequence. To input an Arabic number, a one-number code is needed. To input one English letter, a two-number code is needed. To input a Chinese character, a three-number code which represents the first three strokes or radicals in consequence is needed. If a Chinese character has less than 3 strokes or radicals, one or two predetermined numbers are used to make up the three-number code. If a Chinese character has more than 3 strokes or radicals, one more number which represents the last stroke or radical is added to form a four-number code. If more than one character share the same code, a selection number is needed to select the intended character.

Following are examples of inputting Chinese characters with the method of the present invention.

For example, if the user needs to input the character “ [symbol] ”, the strokes are divided into [symbol] in sequence. According to Table 4, there are four numbers represent the four strokes respectively. Therefore the numeral code is 1081.

If the user needs to input the character “ [symbol] ”, the strokes are divided into [symbol] [symbol] . According to Table 4, there are four numbers represent the four strokes respectively. Therefore the numeral code is 2218.

For character “ [symbol] ”, the stroke are [symbol] Only two numbers 8 and 7 are needed to represent the strokes. Then one predetermined fixed number is needed to add at the end. For example, if the fixed number is determined as 5, the numeral code is 875.

For character “ [symbol] ”, it is divided into strokes of [symbol] There are 7 strokes, the numeral code is supposed to be 2085886 according to Table 4 which is more than 4 digits. Then only the first, the second, the third, and the last digits are taken. Therefore, the numeral code is 2086.

When a Chinese character is more complex, it may be divided into radicals which consists of one or more strokes. In the preferred embodiment of the present invention, two numbers represent the first and last strokes of the radical are used to represent the radical itself.

Most of Chinese characters have two radicals. So using the two-digit code represents each radical will represent the character. If one radical only has one numeral code, the other radical needs three numbers: the first, the second, and the last numbers representing the strokes of the radical.

For example, the character “ [symbol] ” is divided into two radicals. One is “ [symbol] ”, the respective numeral code for [symbol] is 5, another radical is “ [symbol] ”, the strokes are [symbol] [symbol] and the respective numeral code is 2085886. Take the first, the second, and the last numeral code which is 206. Therefore, the respective numeral code of [symbol] is 5206.

The character “ [symbol] ” is divided into two radicals. The last one is [symbol] and the respective numeral code is 2. The first radical is “ [symbol] ”, and the respective numeral code is 1081, take the first, second, and last 101. Therefore, the respective numeral code for “ [symbol] ” is 1012.

For character “ [symbol] ”, one radical is “ [symbol] ”, and the respective numeral code is 971, take the first and last strokes, the code is 91. Another radical is “ [symbol] ”, and the respective numeral code is 2085886. Take the first and last strokes, the code is 26. Therefore, the respective numeral code for “ [symbol] ” is 9126.

In an alternative embodiment of the present invention, 50 numerical codes are assigned to frequently using Chinese radicals as following:

TABLE 5

| | 0 | 1 | 2 [symbol] | 3 | 4 | 5 | 6 | 7 | 8 | 9 |
|---|---|---|---|---|---|---|---|---|---|---|
| 0 | □ | [symbol] | [symbol] | [symbol] | [symbol] | [symbol] | [symbol] | [symbol] | [symbol] | [symbol] |
| 1 | □ 1 | [symbol] 1 | [symbol] 1 | [symbol] 1 | [symbol] 1 | [symbol] 1 | [symbol] 1 | [symbol] 1 | [symbol] 1 | [symbol] 1 |
| 2 | [symbol] 0 | [symbol] 2 | [symbol] 2 | [symbol] 2 | [symbol] 2 | [symbol] 2 | [symbol] 4 | [symbol] 0 | [symbol] 2 | [symbol] 2 |
| 3 | 3 | [symbol] 3 | [symbol] | [symbol] | [symbol] 3 | [symbol] 3 | [symbol] 3 | [symbol] 3 | [symbol] 3 | [symbol] 3 |
| 5 | [symbol] 8 | [symbol] 8 | [symbol] 8 | | [symbol] 8 | [symbol] 8 | [symbol] 8 | [symbol] 8 | | [symbol] 8 |

Referring to Table 5, the reasons of the assignment of the above Chinese radicals are:

With a regulation number 0, the assignment of following radicals is:

[symbol] =0, because it looks similar to 0.

[symbol] =1, it can be written like a [symbol] . [symbol] (means gold)=1, because gold represents the first place.

[symbol] =2, because it looks similar to 2; [symbol] =2 because it looks similar to 20;

[symbol] (means water)=3, because it has three drops.

[symbol] =4, because it looks similar to 4.

[symbol] looks similar to V (Roman number 5); [symbol] =5 because it looks similar to 5.

[symbol] (means worm) because 6 looks similar to a small worm with its head heading downward, and its tail upward.

[symbol] =7 because it is the radical of the Chinese numeral figure [symbol] (7). [symbol] =7 because its first two strokes is [symbol] (7).

[symbol] =8, because it looks similar to 8; [symbol] looks similar to Chinese numeral figure

[symbol]

[symbol] =9, its first stroke is [symbol] (1), and the last two strokes is [symbol] (8), 1 plus 8=9; [symbol] =9, because its upper part is [symbol] (9).

With a regulation number 1, the assignment of following radicals is:

[symbol] =01, because it looks similar to 0.

[symbol] =11, because both of its first and last stroke is a [symbol] which means one.

[symbol] =21, because its first two strokes is [symbol] (means 2), its last part is [symbol] (1).

[symbol] =31, because they looks similar to Chinese numeral figure [symbol] (means 3), and the last stroke is [symbol] (1).

[symbol] =41, because its outside part is [symbol] a square [symbol] in Chinese a square means 4, inner part is [symbol] (1).

[symbol]

=51, because it also written as [symbol] (it looks similar to [symbol] ) and the whole character looks similar to a five pointed star. [symbol] its first part is [symbol] (5), the last part is [symbol] (1), [symbol] also written as

[symbol]

[symbol] =61, because [symbol] (means horse) is the first one of the six domestic animals, horse, cow, sheep, chicken, dog & swine, and its last part is [symbol] (1).

[symbol] =71, because in hand writing, people always written [symbol] as Chinese numeral figure [symbol] (7) like this “ [symbol] ” instead of these [symbol] .

[symbol] =81, because the upper portion of [symbol] is [symbol] (8), therefore, the first digit of [symbol] is 8.

[symbol] =91. because the first stroke of [symbol] is [symbol] (9).

With a regulation number 2, the assignment of following radicals is:

[symbol] =00, because its upper and lower part is [symbol] (0).

[symbol] =12, because its first stroke is | and last two strokes is [symbol] (2).

[symbol] =22, because its first part is [symbol] (2), last part is [symbol] (2).

[symbol] =32, because it looks similar to a 3 lie down face up, and its last two strokes are [symbol] (2).

[symbol] =42, because its outside part is [symbol] a square (4), inner part is [symbol] (2).

[symbol] =50, [symbol] (five words poem) is known to every body in Chinese, therefore we assign [symbol] =5, and the last part of [symbol] is [symbol] (0).

[symbol] =64, because its first stroke is [symbol] (6), the last part is [symbol] (4).

[symbol] =70, because its first two strokes is [symbol] (7) and the last part is [symbol] (0).

[symbol] =82, because both of its left and right part is similar to 8.

[symbol] =92, because the 1^{st} stroke of [symbol] is [symbol] (9), the last two shakes is [symbol] (2).

With a regulation number 2, the assignment of following radicals is:

All radicals of this regulation is not a complete word, their last digit is 3.

=03, because has a first part [symbol] (0),

[symbol] =13, because its main stroke is | (1).

[symbol] =23, because the first two strokes sometimes are written like [symbol] (2); [symbol] =23 because it looks similar to [symbol] (2).

[symbol] =33, because the first stroke of [symbol] is [symbol] (3).

[symbol] =43, because [symbol] has a cross as 4.

[symbol] =5, because they looks similar to the upper of 5,

[symbol] =63, because the first two strokes is [symbol] (6).

[symbol] =73, because the pronunciation of [symbol] is similar to 7, [symbol] similar to Chinese numeral figure [symbol] (7).

[symbol] =83, because they looks similar to (8).

[symbol] =93, because its first stroke is [symbol] (9).

In this embodiment of the present invention, if a Chinese character comprises two radicals, using the two digit codes of each radical can represent the character. For example, character “ [symbol] ” comprises two “ [symbol] ” which numeral code is 22 referring to Table 5. Therefore the numeral code for “ [symbol] ” is 2222.

Chinese characters are usually composed by one to several strokes or radicals, if the character is a unitary structure, use the first, second, third and last strokes representing numeral code; for example, character “ [symbol] ” has strokes [symbol] , its number is 9477. If the character comprises two radicals, such as “ [symbol] ”, the strokes of “ [symbol] ” are [symbol] [symbol] and strokes of “ [symbol] ” are “ [symbol] ”, the first and last strokes of [symbol] and [symbol] is 8849. If a Chinese character has three radicals, such as “ [symbol] ” it has radicals [symbol] , but [symbol] has only one digit 5, then [symbol] can take two digit 73, and the last digit is [symbol] 0. If a Chinese character comprises four or more radicals, take the first digit of the first, second, third and last radicals.

It is worth mentioning, Chinese character has two styles: simplified Chinese characters and traditional Chinese characters. The simplified Chinese characters are simplified from the traditional Chinese characters; so many characters are similar in structure but are not the same. For many currently used inputting methods, the user has to switch between simplified Chinese character and traditional Chinese character manually. It is inconvenient. In the present invention, both simplified and traditional characters can be input at the same time. For example, the “ [symbol] ” is a simplified character, its traditional character is “ [symbol] ” which has the radicals [symbol] (2), [symbol] (1), [symbol] (2), and [symbol] (4). Therefore the numeral code is 2124.

Some characters can be divided into different strokes or radicals, the numeral code may be different but all represent the same character. For example, for traditional Chinese character “ [symbol] ” it can be divided into 3 radicals “ [symbol] ” (33), “ [symbol] ” (7), and “ [symbol] ” (82), or, be divided into 3 radicals “ [symbol] ” (33), “ [symbol] ” (7), and “ [symbol] ” (41). Therefore the numeral code of “ [symbol] ” is 3782 or 3741. And also, if we input 3748, a simplify character of [symbol] “ [symbol] ” would come out, because the strokes of a simplified character of “ [symbol] ” is “ [symbol] 33”, “ [symbol] 7”, “ [symbol] 4”, “ [symbol] 8”.

To input the punctuation marks such as periods, commas, colons, semicolons, and question marks, the user can input a numeral code begin with an Arabic number 3, and followed by the second Arabic number based on the appearance of the punctuation mark.

For example, the appearance of the quotation mark is similar to the Arabic number 6. Therefore, the respective numeral code for single quotation mark is 36.

The appearance of period is similar to 0. Therefore, the respective numeral code for period is 30.

The appearance of each semicolon and colon are similar to two solid circles. Therefore, the second numeral code is 8. Therefore, the respective numeral code for semicolon and colon are 38.

The appearance of each comma and question are similar to solid Arabic number 9. Therefore, the respective numeral code for semicolon and colon are 39.

In an alternative embodiment of the present invention, in order to increase the inputting speed, besides the numeral keypad, a full-key board is utilized. Referring the Table 5, the 50 numeral codes for frequently using Chinese radicals are assigned to 50 keys on a full-key keyboard device. For example, the character [symbol] , its numerical code is 41, while using in keypad, the user need to type two number keys, key 4 and key 1. But with full-key keyboard, the user only needs to press one key, for example, the key in column 4 of row one.

Besides Chinese and English characters, character of other languages can also be inputted by the present invention. For example, by assigning a numeral code to each Russian letter, Russian words can also be inputted.

In summary, the numeral inputting method of the present invention has many advantages. First, using numeral keypad with limited keys and size can input different languages. The bulky full-key key board is not necessary. It is very important and convenient for portable electronic devices such as cell phone and PDA. It also can be operated by one hand. Both English and Chinese can be inputted at the same time without switching the language mode. Both traditional and simplified Chinese characters can be inputted at the same time without switching the language or character mode. Other languages can also be inputted.

The numeral codes are assigned to the letters, stroked or radicals based on their appearance and meanings which is easy to remember. So the method of the present invention is easy to learn and practice. Since the inputting is based on the appearance and structure of the character, and is not depending on the pronunciation, it avoids the problems caused by user's accent and incorrect pronunciation, as well as the confusing of homophone. In addition, the user need not observe the screen to select the right character from the homophones.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A numeral inputting method for different languages, comprising the steps of:
(a) assigning an Arabic number “0” to “9” to each basic unit of characters of different languages, wherein said character is divided into one or more basic units with a sequence;
(b) inputting two or more said numbers to represent different languages to be selected, wherein said number is input according to the appearance of said basic unit; and
(c) generating said character in said language in responsive to said numbers being input.

2. The method, as recited in claim 1, wherein said basic unit is assigned by one digit of said number.

3. The method, as recited in claim 1, wherein said basic unit in English is in form of letter “A” to “Z”, while said basic unit in Chinese is in form of stroke or group of strokes.

4. The method, as recited in claim 2, wherein said basic unit in English is in form of letter “A” to “Z”, while said basic unit in Chinese is in form of stroke or group of strokes.

5. The method as recited in claim 1 wherein, in the step (b), one digit of said number is input to represent said Arabic number; two digits of said number are input to represent an English letter; and three or four digits of said number are input to represent a Chinese character, such that said characters of said different languages are generated without switching any language mode.

6. The method as recited in claim 2 wherein, in the step (b), one digit of said number is input to represent said Arabic number; two digits of said number are input to represent an English letter; and three or four digits of said number are input to represent a Chinese character, such that said characters of said different languages are generated without switching any language mode.

7. The method as recited in claim 4 wherein, in the step (b), one digit of said number is input to represent said Arabic number; two digits of said number are input to represent an English letter; and three or four digits of said number are input to represent a Chinese character, such that said characters of said different languages are generated without switching any language mode.

8. The method as recited in claim 4 wherein, in the step (a), said sequence is from left to right in English, said sequence is from left to right, from top to bottom, from outside to inside in Chinese.

9. The method as recited in claim 7 wherein, in the step (a), said sequence is from left to right in English, said sequence is from left to right, from top to bottom, from outside to inside in Chinese.

10. The method, as recited in claim 7, wherein Arabic numeral “1” is assigned as the first digit of said number to be input for representing English letter of “DHRMFKGLBP”, Arabic numeral “2” is assigned as the first digit of said number to be input for representing English letter of “OIUEAYCTSN”, and Arabic numeral “3” is assigned as the first digit of said number to be input for representing English letter of “QJZWXV”, wherein the second digit of said number is input for English letter from “A” to “Z” that appear similar to the Arabic numerals “0” to “9”.

11. The method, as recited in claim 9, wherein Arabic numeral “1” is assigned as the first digit of said number to be input for representing English letter of “DHRMFKGLBP”, Arabic numeral “2” is assigned as the first digit of said number to be input for representing English letter of “OIUEAYCTSN”, and Arabic numeral “3” is assigned as the first digit of said number to be input for representing English letter of “QJZWXV”, wherein the second digit of said number is input for English letter from “A” to “Z” that appear similar to the Arabic numerals “0” to “9”.

12. The method, as recited in claim 7, wherein if the digit of number representing the strokes of radicals of said Chinese character is less than three, one or two predetermined fixed number are added to make the number code in three digits, wherein if said character is divided into more than 4 strokes or radicals, the first three and the last one strokes or radicals are used to represent the character.

13. A numeral inputting system for different languages, comprising:
a plurality of input keys having a plurality of Arabic number “0” to “9” assigning to each basic unit of characters of different languages, wherein said character is divided into one or more basic units with a sequence, wherein two or more said numbers are input to represent different languages to be selected, wherein said number is input according to the appearance of said basic unit; and
means for generating said character in said language in responsive to said numbers being input.

14. The numeral inputting system, as recited in claim 13, wherein said basic unit is assigned by one digit of said number, wherein said basic unit in English is in form of letter “A” to “Z”, while said basic unit in Chinese is in form of stroke or group of strokes.

15. The numeral inputting system, as recited in claim 14, wherein one digit of said number is input to represent said Arabic number; two digits of said number are input to represent an English letter; and three or four digits of said number are input to represent a Chinese character, such that said characters of said different languages are generated without switching any language mode.

16. The numeral inputting system, as recited in claim 15 wherein said sequence is from left to right in English, said sequence is from left to right, from top to bottom, from outside to inside in Chinese.

17. The numeral inputting system, as recited in claim 15, wherein Arabic numeral “1” is assigned as the first digit of said number to be input for representing English letter of “DHRMFKGLBP”, Arabic numeral “2” is assigned as the first digit of said number to be input for representing English letter of “OIUEAYCTSN”, and Arabic numeral “3” is assigned as the first digit of said number to be input for representing English letter of “QJZWXV”, wherein the second digit of said number is input for English letter from “A” to “Z” that appear similar to the Arabic numerals “0” to “9”.

18. The numeral inputting system, as recited in claim 16, wherein Arabic numeral “1” is assigned as the first digit of said number to be input for representing English letter of “DHRMFKGLBP”, Arabic numeral “2” is assigned as the first digit of said number to be input for representing English letter of “OIUEAYCTSN”, and Arabic numeral “3” is assigned as the first digit of said number to be input for representing English letter of “QJZWXV”, wherein the second digit of said number is input for English letter from “A” to “Z” that appear similar to the Arabic numerals “0” to “9”.

19. The numeral inputting system, as recited in claim 15, wherein if the digit of number representing the strokes of radicals of said Chinese character is less than three, one or two predetermined fixed number are added to make the number code in three digits, wherein if said character is divided into more than 4 strokes or radicals, the first three and the last one strokes or radicals are used to represent the character.

20. The numeral inputting system, as recited in claim 16, wherein if the digit of number representing the strokes of radicals of said Chinese character is less than three, one or two predetermined fixed number are added to make the number code in three digits, wherein if said character is divided into more than 4 strokes or radicals, the first three and the last one strokes or radicals are used to represent the character.
